(19) United States
(12) Patent Application Publication
(10) Pub. No.: US 2019/0220918 A1
(43) Pub. Date: Jul. 18, 2019

(54) METHODS AND DEVICES FOR AN AUGMENTED REALITY EXPERIENCE

(71) Applicant: Eric Koenig, Huntington, NY (US)

(72) Inventor: Eric Koenig, Huntington, NY (US)

(21) Appl. No.: 16/362,614

(22) Filed: Mar. 23, 2019

Related U.S. Application Data
(60) Provisional application No. 62/647,609, filed on Mar. 23, 2018.

(51) Int. Cl. G06Q 30/06; G06T 13/40; G06F 3/0486; G06T 11/60; G06T 19/00

(52) U.S. Cl. CPC G06Q 30/0633; G06Q 30/0641; G06T 13/40; G06T 2200/24; G06T 11/60; G06T 19/006; G06F 3/0486

(57) ABSTRACT

Methods and systems for displaying products in an augmented reality environment comprising receiving environment image data associated with an environment, selecting an item to be augmented into the environment, and retrieving item data associated with the item. Furthermore, generating an avatar associated with a user, displaying the avatar and the item into the environment utilizing augmented reality technology, receiving user behavior data related to actions of the user, and modifying the avatar based on the user behavior data.

### PRIORITY

This application claims the benefit of priority from U.S. Provisional Application No. 62/647,609, filed Mar. 23, 2018, which is hereby incorporated herein by reference in its entirety.

### TECHNICAL FIELD

The present disclosure relates generally to an augment reality (AR) experience, and in particular, relates to an augmented reality experience in a retail environment selling particular products for customers.

As such, the present disclosure relates to apparatuses and devices which may be employed in coffee shops or similar commercial entities, for example, and more particularly in advertising or other presentations which are intended to promote, indicate, and/or extol the features and advantages of any product or service being offered for sale.

### BACKGROUND

Conventionally, when an individual shops for an item or product, the individual must visualize what the item will look like in a particular environment or how that item may interact with a user. In numerous cases, the individual may purchase the item to only realize that the item does not ideally fit their vision of its use. As a result, the individual may not find the experience of shopping for such an item to be a positive experience, therefore, reducing the chances of them being a repeat customer.

One way to deal with this is utilizing augmented reality (AR) to focus on combining real world and computer-generated data, especially computer graphics objects blended into real footage in real time for display to an end-user. The scope of AR has expanded to include non-visual augmentation and broader application areas, such as advertising, navigation, and entertainment. There is increasing interest in providing seamless integration of such computer-generated data, including images and non-visual augmentation data, into real-world scenes.

The use of mobile devices, such as cellular phones or personal digital assistant (PDA) devices, has increased dramatically in recent years. Often, such mobile devices include a camera and display for displaying images at which the camera is pointed. Since people usually carry their camera-capable mobile devices with them to a number of settings, a number of AR mobile applications for utilizing the camera and display capabilities of such mobile devices have emerged.

However, what is needed is an AR environment which not only utilizes augmented reality but provides an interactive AR experience responsive to a customer's needs in a retail setting.

### SUMMARY

An object of the invention is to provide a new and improved Augmented Reality Environment.

In an exemplary embodiment, a method for displaying products in an augmented reality environment, comprising receiving environment image data associated with an environment, selecting an item to be augmented into the environment, and retrieving item data associated with the item. The exemplary method may further comprise generating an avatar associated with a user, displaying the avatar and the item into the environment utilizing augmented reality technology, receiving user behavior data related to actions of the user, and modifying the avatar based on the user behavior data.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for the purpose of illustration and description only and are not intended as a definition of the limits of the present disclosure. Embodiments of the present disclosure will now be described by way of example in association with the accompanying drawings in which:

FIG. 1 is a high-level client-server-based network architecture to enable visualization of items in an environment using augmented reality, consistent with one or more exemplary embodiments of the present disclosure;

FIG. 2 is a block diagram illustrating multiple components that are provided within an exemplary publication system or an exemplary networked system, consistent with one or more exemplary embodiments of the present disclosure;

FIG. 3 is a block diagram illustrating an example embodiment of the augmented reality engine, consistent with one or more exemplary embodiments of the present disclosure;

FIG. 4 is a flow diagram of an example high-level method for visualization of an item in an environment using augmented reality, consistent with one or more exemplary embodiment of the present disclosure; and

FIG. 5 is a flow diagram of an example high-level method for generating the augmented reality image, consistent with one or more exemplary embodiments of the present disclosure.

### DETAILED DESCRIPTION

In an exemplary embodiment, a user may install a mobile application on an exemplary mobile device. In an exemplary embodiment, the user may create a user profile, containing personal information to include but not limited to name, date of birth, address, gender, occupation, hobbies, and interests. In an exemplary embodiment, a user profile may be created related to the user based on data associated with the user, user behavior, and/or monitoring of user behavior.

Exemplary methods and devices allow a user to arrive at a retail location and view additional information related to products available there in an augmented reality environment. Furthermore, in an exemplary embodiment, a user may be able to visualize impact of user of an item or product as described in further detail below. For example, a selection of a particular item may show its expected impact on an exemplary avatar displayed in an augmented reality (AR) environment. A user may further be able to purchase an item and have it delivered to them or packaged for their pick-up, amongst other ways to provide products, consistent with one or more exemplary embodiments.

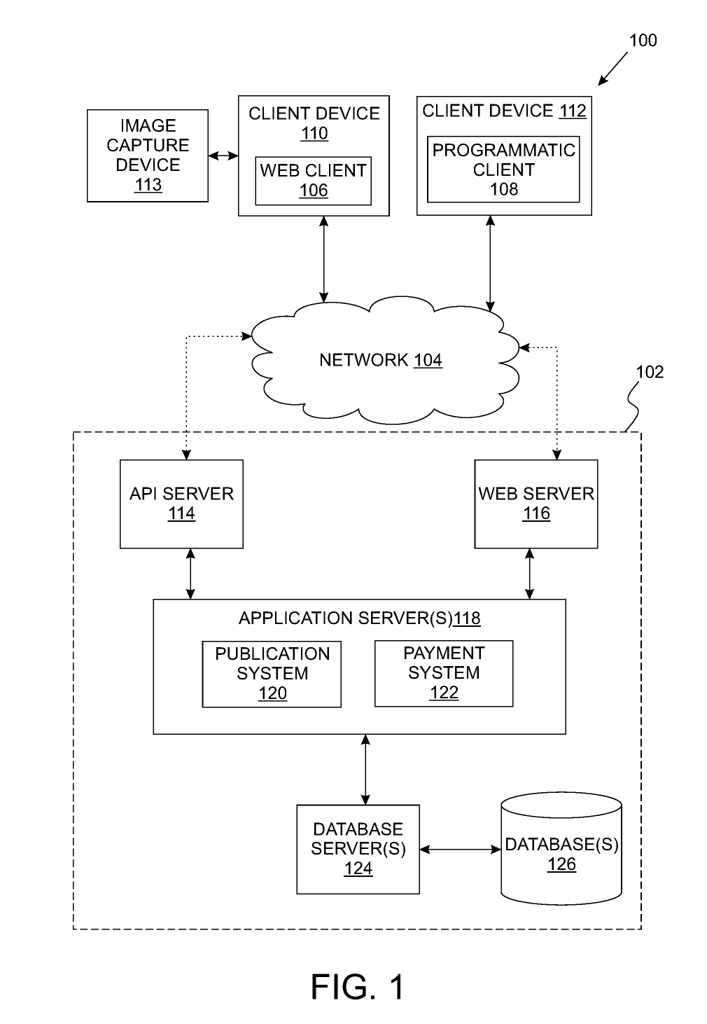

In FIG. 1, an exemplary embodiment of a high-level client-server-based network architecture 100 to enable visualization of items in an environment using augmented reality is shown, consistent with one or more exemplary embodiments of the present disclosure. A networked system 102, in an example form of a network-server-side functionality, may be coupled via a communication network 104 (e.g., the Internet, wireless network, cellular network, or a Wide Area Network (WAN)) to one or more client devices 110 and 112. FIG. 1 illustrates, for example, a web client 106 may operate a browsing system via a programmatic client 108 executing on respective client devices 110 and 1 12.

The client devices 110 and 112 may comprise a mobile phone, tablet, desktop computer, laptop, or any other communication device that a user may utilize to access the networked system 102. In some embodiments, the client device 110 may comprise or be connectable to an image capture device 113 (e.g., camera, camcorder). In an exemplary embodiment, the client device 110 may comprise one or more of a touch screen, accelerometer, microphone, and GPS device. The client devices 110 and 112 may be a device of an individual user interested in visualizing an item within an environment.

An Application Program Interface (API) server 114 and a web server 116 may be coupled to, and provide programmatic and web interfaces respectively to, one or more application servers 118. Application servers 118 may host a publication system 120 and a payment system 122, each of which may comprise one or more modules, applications, or engines, and each of which may be embodied as hardware, software, firmware, or any combination thereof. The application servers 118 may, in turn, be coupled to one or more database servers 124 facilitating access to one or more information storage repositories or database(s) 126. The databases 126 may also store user account information of the networked system 102 in accordance with an exemplary embodiment.

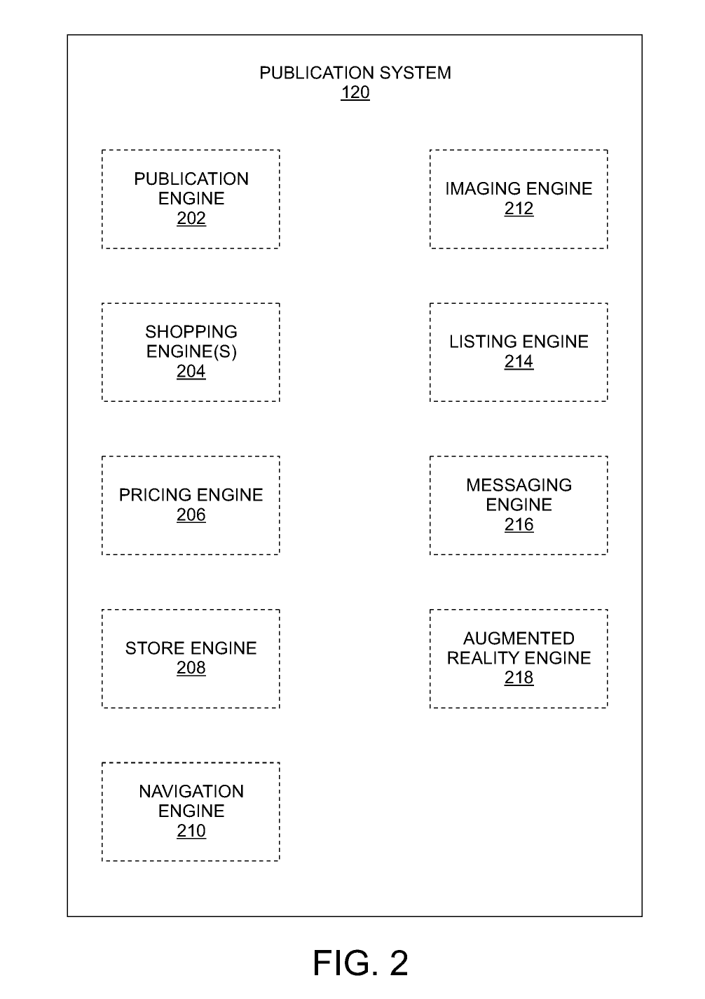

In an exemplary embodiment, the publication system 120 may publish content on a network, e.g., internet, intranet, or a similar environment in a retail setting. As such, the publication system 120 may provide a number of publication functions and services to users that access networked system 102. Publication system 120 is discussed in more detail with respect to FIG. 2. In an exemplary embodiment, the publication system 120 is discussed in terms of a marketplace environment. However, it is noted that the publication system 120 may be associated with a non-marketplace environment such as an informational or social networking environment.

The payment system 122 may provide a number of payment services and functions to users. The payment system 122 may allow users to accumulate value (e.g., in a commercial currency, such as the U.S. dollar, or a proprietary currency, such as “reward points”) in their accounts, and then later to redeem the accumulated value for products (e.g., goods or services) that are made available via the publication system 120 or elsewhere on the network 104. The user may also receive specialized coupons or provided discounts based on their user profile, including previous purchases, their status as a new or a tiered customer, etc. The payment system 122 may also facilitate payment from a payment mechanism for purchases of items via any type and form of a network-based marketplace.

While the publication system 120 and the payment system 122 are shown in FIG. 1 to both form part of the networked system 102, it will be appreciated that, in alternative embodiments, the payment system 122 may form part of a payment service that is separate and distinct from the networked system 102. Additionally, while the example network architecture 100 of FIG. 1 employs a client—server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

FIG. 2 is a block diagram illustrating multiple components that are provided within the publication system 120 of the networked system 102, consistent with one or more exemplary embodiments of the present disclosure. In an exemplary embodiment, publication system 120 may be a marketplace system where items (e.g., goods or services) may be offered for sale. In another exemplary embodiment, publication system 120 may be a social networking system or informational system. The publication system 120 may be hosted on dedicated or shared server machines (not shown) that may be communicatively coupled to enable communications between the server machines. The multiple components themselves may be communicatively coupled (e.g., via appropriate interfaces), either directly or indirectly, to each other and to various data sources, to allow information to be passed between the components or to allow the components to share and access common data. Furthermore, the components may access the one or more databases 126 via the one or more database servers 124.

In an exemplary embodiment, publication system 120 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more shopping engines 204. In an exemplary embodiment, the shopping engines 204 may support auction-format listing and price setting mechanisms (e.g., English, Dutch, Chinese, Double, Reverse auctions, etc.).

A pricing engine 206 may support various price listing formats. One such format is a fixed-price listing format. Additional exemplary formats of sales may be offered that allow a buyer to purchase goods or services.

A store engine 208 may allow a seller to group listings within a “Virtual” store, which may be branded and otherwise personalized by and for the seller. Such a virtual store may also offer promotions, incentives, and features that are specific and personalized to the seller. In an exemplary scenario, a seller may offer a plurality of items as Buy-It-Now items in the virtual store, offer a plurality of items for auction, or a combination of both. Alternatively, store engine 208 may allow a seller to provide information regarding for-sale-products in a retail setting or environment. In an exemplary embodiment, at a physical retail shop or in an online setting, a user may either browse the available inventory by brands or they may browse the available inventory by product type. For example, for a legal retail dispensary providing Cannabis related products, the products may include flower, concentrate, vape pen, edibles, glass, papers, etc.

Navigation of the publication system 120 may be facilitated by a navigation engine 210. For example, a search module (not shown) of the navigation engine 210 enables, for example, keyword searches of listings or other information published via the publication system 120. In a further example, a browse module (not shown) of the navigation engine 210 allows users to browse various categories, catalogs, or data structures according to which listings or other information may be classified within the publication system 120. Various other navigation applications within the navigation engine 210 may be provided to supplement the searching and browsing applications. In an exemplary embodiment, navigation engine 210 may allow the user to search or browse for items in the publication system 120 (e.g., virtual stores, listings in a fixed-price or auction selling environment, listings in a social network or information system). In an exemplary embodiment, the navigation engine 210 may navigate (e.g., conduct a search on) a network at large (e.g., network 104). Based on a result of the navigation engine 210, the user may select an item that the user is interested in augmenting into an environment. In order to make listings or posting of information available via the networked system 102 as visually informing and attractive as possible, the publication system 120 may include an imaging engine 212 that enables users to upload images for inclusion within listings and to incorporate images within viewed listings. In an exemplary embodiment, imaging engine 212 may also receive image data from a user and utilizes the image data to generate the augmented reality image. For example, the imaging engine 212 may receive an environment image (e.g., still image, video) of an environment within which the user wants to visualize an item. The imaging engine 212 may work in conjunction with the augmented reality engine 218 to generate the augmented reality image as will be discussed in more details below.

A listing engine 214 may manage listings on the publication system 120. In an exemplary embodiment, listing engine 214 may allow users to author listings of items. The listing may comprise an image of an item along with a description of the item. In an exemplary embodiment, the listings pertain to goods or services that a user (e.g., a seller) may wish to transact via the publication system 120. As such, the listing may comprise an image of a good for sale and a description of the item such as, for example, dimensions, color, and identifier (e.g., UPC code, ISBN code). In an exemplary embodiment, a user may create a listing that may be an advertisement or other form of publication to the networked system 102. The listing engine 214 may also allow the users to manage such listings by providing various management features (e.g., auto-relisting, inventory level monitors, etc.).

A messaging engine 216 may be responsible for the generation and delivery of messages to users of the networked system 102. Such messages include, for example, advising users regarding the status of listings and best offers (e.g., providing an acceptance notice to a buyer who made a best offer to a seller) or providing recommendations. The messaging engine 216 may utilize any one of a number of message delivery networks and platforms to deliver messages to users.

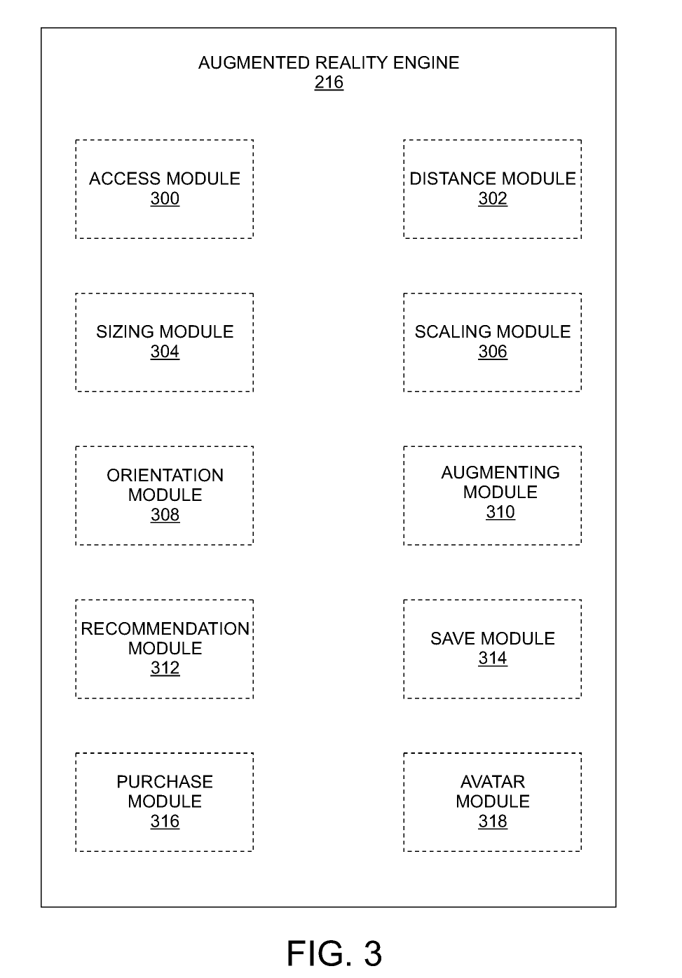

An augmented reality engine 218 may manage the generation of an augmented reality based on an environment image and item specified by a user. The augmented reality engine 218 will be discussed in more detail in connection with FIG. 3 below.

Although the various components of the publication system 120 have been defined in terms of a variety of individual modules and engines, a skilled artisan will recognize that many of the items can be combined or organized in other ways.

Alternatively, not all components of the publication system 120 of FIG. 2 may be utilized. Furthermore, not all components of the marketplace system 120 have been included in FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

FIG. 3 is a block diagram illustrating an augmented reality engine 216, consistent with one or more exemplary embodiments of the present disclosure. In an exemplary embodiment, augmented reality engine 216 may comprise an access module 300, a distance module 302, a sizing module 304, a scaling module 306, an orientation module 308, an augmenting module 310, a recommendation module 312, a save module 314, a purchase module 316, and an avatar module 318. In additional embodiments, functions of one or more of the modules of the augmented reality engine 216 may be combined together, one or more of the modules may be removed from the augmented reality engine 216, or one or more of the modules may be located elsewhere in the networked system 102 (e.g., the imaging engine 214, shopping engines 204) or at the client device 110.

In an exemplary embodiment, imaging engine 212 may receive or retrieve (for example, in a retail setting) environment image data of an environment (e.g., still image, video) from client device 110. The environment image data may then be provided to the augmented reality engine 216 for processing. In an exemplary embodiment, the augmented reality engine 216 may also receive item data for an item that a user may interested in visualizing in the environment and an indication of a location where the item is to be augmented in the environment. The item data may be provided by the navigation engine 210 based on a user selection of an item found using a search or browsing function of the navigation engine 210.

Alternatively, the item data may be received from the client device 110. For example, the user may capture an image of an item that the user is interested in augmenting into the environment (e.g., take a photo of an item at a store). The user may, in some cases, enter information regarding the item such as dimensions or an identifier, such as a UPC code. The augmented reality engine 216 may receive the item data from the client device 110.

The access module 300 accesses item data for a selected item. In an exemplary embodiment, an item to be augmented into the environment may be selected by a user at the client device and the selection is received, for example, by the navigation engine 210. In an exemplary embodiment, the selection may be received by the access module 300. Based on the selection, the access module 300 may access information corresponding to the selection. If the selection is an item listing for the item, the access module 300 may access the item listing and extract item data (e.g., dimensions, images) from the listing. In other examples, if the selection is a user inputted name or other item identifier of an item (e.g., UPC code), the access module 300 may access a catalog (e.g., stored in the database 126) that stores item data using the item identifier.

The distance module 302 determines a distance to a focal point in an image of the environment. The focal point may be a user selected area (also referred to as an “indicated location”) where an item image is to be augmented. For example, if the environment is a room, the distance to a wall where the item image is to be augmented may be determined. In one embodiment, the distance module 302 may use a focus capability of the image capture device 1 13 of, or coupled to, the client device 110 to determine the distance. Alternatively, the distance module 302 may use an echo technique using the client device 110 as a sound generator to determine the distance. For example, the client device 110 may generate a sound in the direction of the wall and an amount of time is registered for an echo to be returned. The distance module 302 may use this amount of time to determine the distance. As such, the distance is from a point of view of the viewer or image capture device (e.g., camera) to the focal point.

The sizing module 304 determines sizing for the environment. In example embodiments, the sizing module 304 uses a marker (an object with known standard dimensions) in the environment image data to calculate the sizing. For example, if a door is shown in the environment image data, the sizing module 304 may assume that the door is a standard sized door (e.g., 36″ x 80″) or that a door knob is located at 36″ from the floor. Using these known standard dimensions, sizing for the environment may be determined. In another example, if the environment is an automobile, the marker may be a wheel well of the automobile. In this example, the user may specify a type of automobile when providing the environment image data.

The scaling module 306 scales an image of the item based on the distance and sizing determined by the distance module 302 and the sizing module 304, respectively. Accordingly, the scaling module 306 may receive (e.g., from the navigation engine 210) or retrieve the item data (e.g., from the database 126) for a selected item. The item data may include an item image, dimensions, or an item identifier. If the item image and dimensions are provided, then the scaling module 306 may use the item image and the dimensions to scale the item image to the environment based on the sizing determined by the sizing module 304. Alternatively, if one of the image or dimension is not provided, the item identifier may be used to look up the item in an item catalog which may contain an image and item information for the item (e.g., dimensions and description). In one embodiment, the scaling module 306 may look up and retrieve the item information from the item catalog.

Once the item image is scaled, the scaled item image may be oriented to the environment by the orientation module 308. For example, if the environment image has a wall at a slight angle and the scaled item image is to be placed on the wall, the orientation module 308 orients the scaled item image to the angle of the wall. It is noted that functionality of any of the distance module 302, sizing module 304, scale module 306, and orientation module 308 may be combined into one or more modules that can determine proper sizing and orientation for the item image. In some embodiments, these combined modules may comprise or make use of one or more gyroscopes or accelerometers.

The augmenting module 310 augments the scaled and oriented item image with the environment image to create an augmented reality image. The augmenting module 310 then provides the augmented reality image to the client device 110. The recommendation module 312 optionally provides recommendations for alternative items for the environment. For example, if the scaled and oriented item image appears too large for an indicated area on the environment image (e.g., as determined by the augmenting module 310), the recommendation module 312 may suggest one or more alternative items that are smaller and will fit better in the indicated area. Accordingly, the recommendation module 312 may determine a dimension that is more appropriate for the indicated area and perform a search (e.g., provide instructions to the navigation engine 210 to perform a search) to find one or more alternative items. The recommendation module 312 may then retrieve the item information and provide the alternative items as a suggestion to the user. In one embodiment, the alternative items may be listed on a side of a display that is displaying the augmented reality image or on a pop-up window.

The save module 314 may save the environment image for later use. In one embodiment, the environmental image may be stored to the database 126 of the networked environment 102. Alternatively, the environmental image may be stored to the client device 110. For example, the user may record the environmental image for a room and save the environmental image. At a later time, the user may obtain an item image for an item that the user is interested in augmenting into the saved environmental image. The save module 314 may access and retrieve the saved environmental image.

The purchase module 316 may allow the user to purchase the item that is augmented into the environment or an alternative item recommended by the recommendation module 312. In one embodiment, the purchase module 316 may provide a selection on or near the augmented reality image that when selected takes the user to, for example, a purchase page for the item, a store front for a store that sells the item, or search page with search results for availability of the item for purchase. In another embodiment, an activation of the selection may initiate an automatic purchase of the item. Once selected, the purchase module 316 may perform the corresponding actions to facilitate the purchase (e.g., send a search for the item to the navigation engine 210, provide one or more listings using the shopping engine 204, provide a webpage associated with the store engine 208).

Avatar module 318 may generate an avatar for a particular user based on their user profile. Exemplary avatar may represent a user or may be a general character associated with a user. Exemplary avatar may be used as a virtual test pilot by a user. Accordingly, a user may drag and drop a 2D or a 3D AR model of a product/item onto the exemplary avatar. The avatar module 318 may responsive to that action generate a modified avatar which indicated impact of the product onto an avatar. For example, if the product may provide a feeling of energy and exuberance to a user, the avatar may appear energetic and exuberant. Accordingly, a user may be able to visualize the impact that may occur on them.

In an exemplary embodiment, a product or product display may itself becomes a digital avatar in order to communicate with the user.

In an exemplary embodiment, an analogous step similar to step 304 may be done for placement of the avatar. Accordingly, a secondary focal point may be determined for an exemplary avatar.

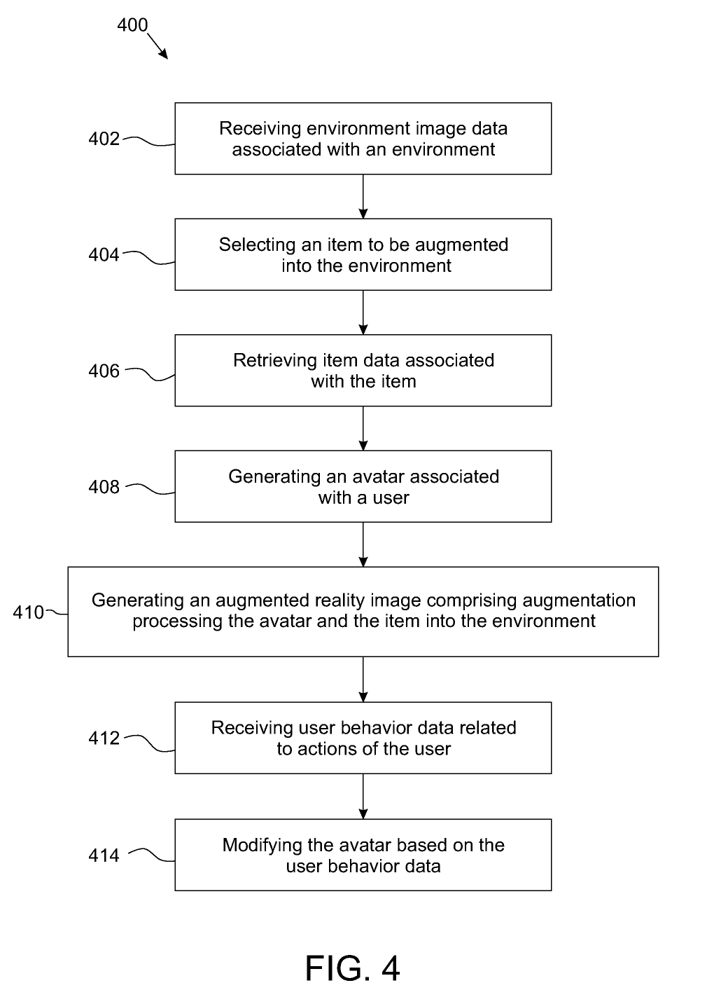

FIG. 4 is a flow diagram of a method 400 for visualization of an item in an environment using augmented reality, consistent with one or more exemplary embodiments of the present disclosure.

Step 402 may include receiving environment image data associated with an environment. In an exemplary embodiment, the imaging engine 212 may receive the environment image data from a client device 110. The environment image data may comprise an image of an environment into which the user wants to augment an item image. For example, it may also be data associated with location of various items and displays in a retail space environment.

Step 404 may include selecting an item to be augmented into the environment. In an exemplary embodiment, the navigation engine 210 may receive a selection of the item from the client device. In an exemplary embodiment, the imaging engine 212 may receive an image of an item that the user is interested in augmenting into the environment. In an exemplary embodiment, a retailer may select the items to be augmented.

Step 406 may include retrieving item data associated with the item. In an exemplary embodiment, based on the received selection of the item, item data may be accessed or retrieved. The access module 300 may retrieve item data for the selected item. The item data may be extracted from an item listing for the item, retrieved from an item catalog, or retrieved from a website of a manufacturer or reseller (e.g., using an item identifier of the item). Additionally, item data may further include data which comprises information regarding the item or products potential impacts on a user and or its display properties.

Step 408 may include generating an avatar associated with a user. For example, as discussed above with respect to avatar module 318 an avatar may be generated which may be associated with the user. In an exemplary embodiment, if a previous avatar associated with a user has been generated, step 408 may alternatively entail retrieving the previously generated avatar associated with the user.

Step 410 may comprise generating an augmented reality image comprising augmentation processing the avatar and the item into the environment utilizing augmented reality technology. In an exemplary embodiment, augmentation processing may refer to taking the avatar, environment image data, and the selected item, and augmenting or merging an item image for the item into an environment image. For example, in a remote location or a physical retail store, an avatar, along with a 3D model of a production may be displayed in an augmented reality environment.

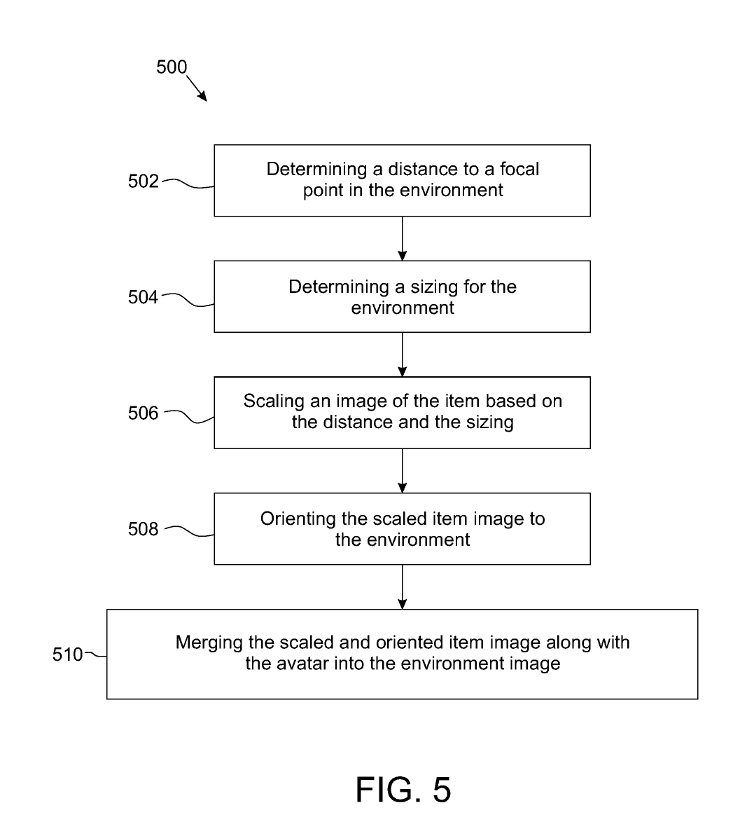

FIG. 5 provides the details of steps 410, specifically, the detailed steps of the augmentation processing, consistent with one or more exemplary embodiments of the present disclosure. Accordingly, FIG. 5 is a flow diagram of a method (step 410) for generating the augmented reality image. Step 502 may include determining a distance utilizing the distance module 302. The distance module 302 may determine a distance to a focal point in the environment. The focal point may be a user selected area where an item image is to be augmented. In an exemplary embodiment, the distance module 302 may use capabilities (e.g., focus, echo based on sound) of the image capture device 113 of, or coupled to, the client device 110 to determine the distance.

Step 504 may comprise sizing for the environment is determined by the sizing module 304. In example embodiments, the sizing module 304 may use a marker in the environment image data to calculate the sizing. Using known standard dimensions of the marker, sizing for the environment may be determined by the sizing module 304.

Step 506 may comprise scaling in the image item. In an exemplary embodiment, an image is scaled in operation 506. The scaling module 306 may scale an image of the item based on the distance and sizing determined by the distance module 302 and the sizing module 304, respectively. Accordingly, the scaling module 306 may receive or retrieve the item data including an item image, dimensions, or an item identifier. The retrieved item data may then be used in association with the determined distance and sizing data to scale the item image.

Once the item image is scaled, the scaled item image may be oriented to the environment, in step 508, by the orientation module 308. For example, if the environment image has a wall at a slight angle and the scaled item image is to be placed on the wall, the orientation module 308 may orient the scaled item image to the angle of the wall.

Step 510 may comprise merging the scaled and oriented item image along with the avatar into the environment image. The augmenting module 310 may augment the scaled and oriented item image with the environment image to create an augmented reality image.

It is noted that operations of FIG. 5 may be combined into fewer operations. Alternatively, some of the operations of FIG. 5 may be optional.

The result of the augmentation may be provided in step 410. The result may comprise a video of the environment with the selected item augmented into the environment (referred to as “the augmented reality image”). In example embodiments, the augmenting module 310 provides the augmented reality image to the client device 110 of the user that provided the environment image, the item selection, or both.

Referring back to FIG. 4, step 412 may comprise of receiving user behavior data related to actions of the user. In an exemplary embodiment, user behavior may be associated with explicit user selection. For example, this may entail a user selling a particular brand or product. In another exemplary scenario, a user may drag a product on to an exemplary avatar to see what impact the product may hypothetically have on the user. In an exemplary embodiment, user behavior may also include amount of time a user interacts with a particular product. Accordingly, even if a user has not explicitly selected a product to see the item/product interaction with the exemplary avatar, step 414 may still progress. In an exemplary embodiment, user behavior may also entail the physical location of a user in context of a displayed environment, the angle they may be holding a client device, and any other user profile information, such as that a user normally makes a decision within two minutes on each visit.

Step 414 may comprise of modifying the avatar based on the user behavior data. For example, based on the user behavior, a determination is made as to whether a modification is received. In an exemplary embodiment, the avatar may simply be modified due to movement of the image capture device 113. For example, if the image capture device 113 is a video camera, then the modification is the movement within the environment as captured by the video camera. In another embodiment, the user may select an alternative item based on a recommendation provided by the recommendation module 312. Based on the modification, the method 400 may return to either operation 406 to access item data for the new item or to operation 408 to perform augmentation processing based on, for example, the movement within the environment. Additionally, in the exemplary scenario, where a user seeks to see behavior of an avatar based on interaction with an item, such modification may be made to the avatar based on pre-stored settings.

In an exemplary embodiment, the modified avatar may be displayed instead of the previously generated avatar.

Other embodiments incorporating various modifications and alterations may be used in the design and manufacture of the apparatus consistent with exemplary embodiments of the present disclosure without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “front”, “back”, “vertical”, “horizontal”, “up”, “down”, and “side-to-side” are used in a relative sense to the normal orientation of the apparatus.

What is claimed:

1. A method for displaying products in an augmented reality environment, comprising:
receiving, using one or more processors, environment image data associated with an environment;
selecting, using the one or more processors, an item to be augmented into the environment;
retrieving, using the one or more processors, item data associated with the item;
generating, using the one or more processors, an avatar associated with a user;
displaying, using the one or more processors, the avatar and the item into the environment utilizing augmented reality technology;
receiving, using the one or more processors, user behavior data related to actions of the user; and
modifying, using the one or more processors, the avatar based on the user behavior data.

2. The method of claim 1, wherein displaying the avatar and the item into the environment utilizing augmented reality technology, comprises:
determining a distance to a focal point in the environment;
determining a sizing for the environment;
scaling an image of the item based on the distance and the sizing;
orienting the scaled item image to the environment; and
merging the scaled and oriented item image along with the avatar into the environment.

3. The method of claim 1, wherein the method further comprising receiving a user input indicating purchase of the item.

4. The method of claim 2, wherein the method further comprising sending a notification for order fulfillment responsive to receiving the user input indicating purchase of the item.

5. The method of claim 1, wherein retrieving item data associated with the item comprises retrieving data associated with known impact of the item in context of various user characteristics.

6. The method of claim 1, wherein generating the avatar associated with the user comprises generating the avatar based on the user's physical appearance.

7. The method of claim 1, wherein modifying the avatar based on the user behavior data comprises modifying the avatar based on the user proactively dragging of the item to the avatar on a display.

8. The method of claim 7, further updating the displayed environment based on modification of the avatar.

9. The method of claim 1, wherein modifying the avatar based on the user behavior data comprises modifying the avatar based on a user interacting with the item over a threshold period of time.
